(19) United States
(12) Patent Application Publication
(10) Pub. No.: US 2024/0394377 A1
(43) Pub. Date: Nov. 28, 2024

(54) DATA SECURITY RISK POSTURE

(71) Applicant: Palo Alto Networks, Inc., Santa Clara, CA (US)

(72) Inventors: Manish Mradul, Milpitas, CA (US); Devendra Mohan Badhani, San Jose, CA (US)

(21) Appl. No.: 18/324,219

(22) Filed: May 26, 2023

(51) Int. Cl. G06F 21/57; G06F 21/55; G06F 21/62

(52) U.S. Cl. CPC G06F 21/577; G06F 21/552; G06F 21/6245; G06F 2221/034

(57) ABSTRACT

A DLP system with ongoing risk assessment establishes a baseline quantification of data loss risk (“risk score”) of assets identified as sensitive assets and quantifies other dynamic factors as components to be combined or viewed with the baseline risk score. The baseline risk score provides an initial or static view of data loss risk for a sensitive asset at-rest and can be combined with other scoring components to provide different views of risk for a sensitive asset that represent more dynamic aspects. These scoring components relate to access activity over time or historical activity and in-transit activity. The baseline risk score with the dynamic risk scoring components provides a current view of risk and a trending or historical view of risk for the sensitive asset. The in-transit risk scoring component tailors risk assessment to a requestor to provide another perspective or contextualize risk with respect to the requestor.

### BACKGROUND

The disclosure generally relates to transmission of digital information (e.g., CPC class H04L) and network architectures for network security (e.g., CPC subclass H04L 63/00).

National Institute of Standards and Technology (NIST) Special Publication 800-128 Guide for Security-Focused Configuration Management of Information Systems defines security posture as “The security status of an enterprise's networks, information, and systems based on information security resources (e.g., people, hardware, software, policies) and capabilities in place to manage the defense of the enterprise and to react as the situation changes.”

NIST Publication 800-30 Revision 1 Guide for Conducting Risk Assessments defines “risk assessment” in chapter 2 as a key component of a holistic, organization-wide risk management process as defined in NIST Special Publication 800-39, Managing Information Security Risk: Organization, Mission, and Information System View. Risk management processes/components include: (i) framing risk; (ii) assessing risk; (iii) responding to risk; and (iv) monitoring risk. According to the NIST Publication, risk assessment is a determination of risk as a function of likelihood of harm occurring and the impact of that harm. This risk management component identifies: (i) threats to organizations (i.e., operations, assets, or individuals) or threats directed through organizations against other organizations or the Nation; (ii) vulnerabilities internal and external to organizations; (iii) the harm (i.e., adverse impact) that may occur given the potential for threats exploiting vulnerabilities; and (iv) the likelihood that harm will occur.

### BRIEF DESCRIPTION OF THE DRAWINGS

Embodiments of the disclosure may be better understood by referencing the accompanying drawings.

FIG. 1 is a diagram of an example security posture manager that scores risk of business critical assets for effective management of the data loss risks of the assets.

FIG. 2 is a diagram of the example security posture manager determining scoring components that quantify dynamic risk aspects and evaluating both the baseline at-rest risk and dynamic scoring components.

FIG. 3 is a flowchart of example operations for scoring baseline at-rest risk of sensitive assets.

FIG. 4 is a flowchart of example operations for obtaining risk assessments for the sensitive assets.

FIG. 5 is a flowchart of example operations for quantifying the baseline at-rest risk assessment for each sensitive asset based on obtained risk assessments.

FIG. 6 is a flowchart of example operations for scoring in-transit risk for a sensitive asset and updating historical activity scoring component.

FIG. 7 is a diagram of a hierarchy of sensitive assets and logical containers with indications of attributes and baseline at-rest risk scores (hereinafter “risk scores”).

FIG. 8 is a flowchart of example operations for determining risk contribution for sensitive assets based on hierarchical relationships of the sensitive assets.

FIG. 9 depicts an example computer system with a security posture manager that scores data loss risk of business critical assets.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Data loss is the loss of control of confidential or sensitive data (“data leakage”) and/or the compromise of integrity or availability of data. The different states of data (i.e., data at rest, data in-motion or in-transit, and data at the endpoint) have different vectors of data loss. While different data loss prevention techniques have been developed for the different vectors of data loss, the different techniques focus on addressing the different loss vectors. However, widespread adoption of hosting data in cloud infrastructures, distributed collaboration and remote working, and increasing scope of data and privacy regulation has yielded an immense amount of data loss prevention (DLP) incidents from DLP systems that are overwhelming for a person to review. The migration of enterprise data to a cloud infrastructure can easily generate hundreds of thousands of DLP incidents, which can render a DLP system ineffective. While “data” in data loss prevention includes program code, this description uses “asset” to refer to data that is program code and data that is not program code to avoid potential confusion.

For an effective DLP system with ongoing risk assessment as disclosed herein, a system establishes a baseline quantification of data loss risk (“risk score”) of assets identified as sensitive assets and quantifies dynamic aspects of risk as scoring components used to adjust the baseline risk score and/or visualized with the baseline risk score. The baseline risk score provides an initial or static view of data loss risk for a sensitive asset at-rest and can be combined with other scoring components to provide different views of risk for a sensitive asset that represent more dynamic aspects. These scoring components relate to access activity over time or historical activity and in-transit activity. The baseline risk score with one or both of these dynamic risk scoring components provides a current view of risk and a trending or historical view of risk for the sensitive asset. The in-transit risk scoring component tailors risk assessment to a requestor to provide another perspective or contextualize risk at the moment and with respect to the requestor. The risk scoring can be used to focus on sensitive assets with the highest data loss risk, effectively presenting business critical assets at risk of data loss or exposed to data loss.

### Example Illustrations

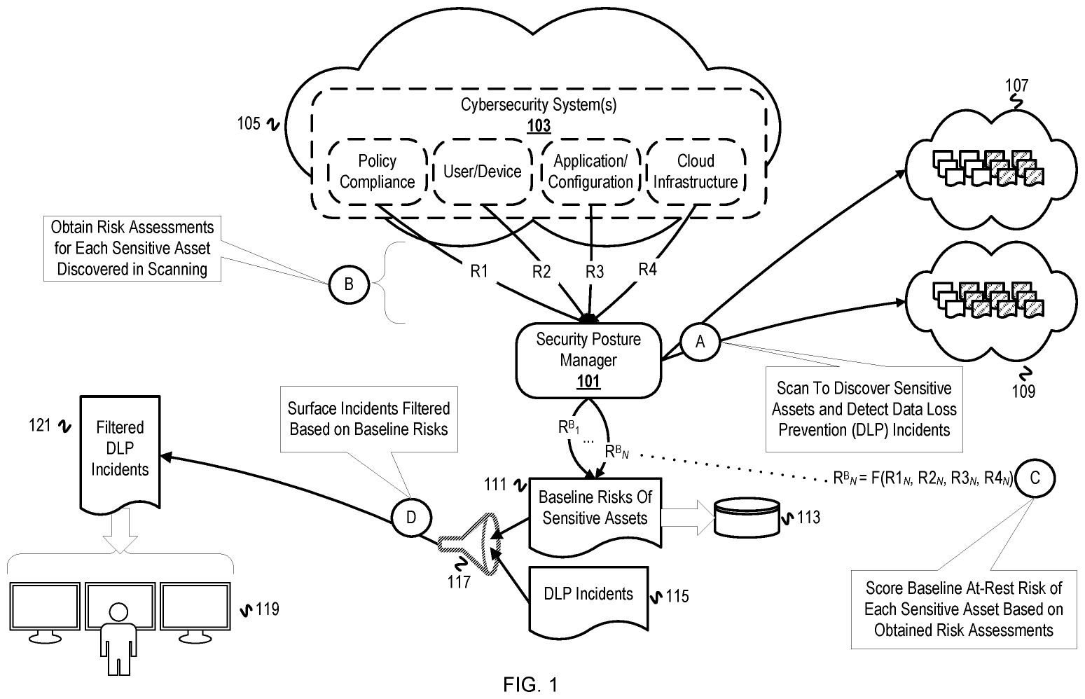

FIG. 1 is a diagram of an example security posture manager that scores risk of business critical assets for effective management of the data loss risks of the assets. A security posture manager 101 interfaces with one or more cybersecurity systems 103 that assess different aspects of cybersecurity risk for managing security posture as related to assets. The “business critical” moniker is used as shorthand to refer to an organization's sensitive assets that are most at risk of data loss as quantified by scoring with respect to a threshold(s) or range determined by the organization. This scoring is used to decide which incidents of data loss to surface to a security operations center 119 in FIG. 1.

FIG. 1 depicts the cybersecurity system 103 in a dashed line with four modules also depicted in dashed lines. The illustration uses the dashed lines to represent the various possible deployments/implementations for one or more cybersecurity systems that assess risk. The illustrated modules represent the risk aspects corresponding to policy compliance, user/device behavior, application/configuration, and cloud infrastructure. The risk assessments for the different risk aspects may be provided by a single system (sometimes referred to as a solution) or multiple systems. While depicted as cloud-based, implementations are not limited to interfacing with cloud-based risk assessment systems. The policy compliance aspect is the risk arising from incidents of non-compliance with defined policies of the organization. The user/device behavior aspect is the risk arising from behavior (as represented by events or activity such as function invocations and application requests) of users and/or devices of the organization. Risk assessment based on user/device behavior includes assessment of an individual user/device and assessment of user/device attributes (e.g., engineering roles accessing financial data or smartphone devices accessing sensitive assets). Since this risk posture manager is primarily concerned with assets in cloud infrastructure, “application” refers to cloud-based applications, such as Software-as-a-Service (“SaaS”) applications or services. The risk assessment for the application/configuration includes assessment of the application generally and configuration of the application by/for the organization. Similarly, risk assessment of the cloud infrastructure aspect of risk refers to assessment of the cloud infrastructure. This is a separate risk assessment from the application/configuration risk aspect since a cloud infrastructure can relate to multiple services or applications.

FIG. 1 also depicts organizational assets being hosted in multiple cloud infrastructures 107, 109. A large organization can have assets in a cloud infrastructure of a first cloud platform or of a first cloud service provider for cloud-based storage/SaaS solutions and assets in a private cloud hosted by a second cloud service provider.

FIG. 1 is annotated with a series of letters A-D representing stages of operations, each of which may be one or more operations. Although these stages are ordered for this example, the stages illustrate one example to aid in understanding this disclosure and should not be used to limit the claims. Subject matter falling within the scope of the claims can vary from what is illustrated.

At stage A, the security posture manager 101 scans cloud infrastructures that host assets of an organization to discover sensitive assets and detect DLP incidents—DLP incidents being matches of DLP settings and/or violations of DLP rules. The security posture manager 101 scans or requests another process to scan cloud infrastructure accounts of an organization to discover assets with attributes that qualify the assets as sensitive. The security posture manager 101 then evaluates the discovered sensitive assets against a DLP settings/rules (hereinafter rules) of the organization to detect DLP incidents 115. FIG. 1 depicts assets in the cloud infrastructures 107, 109 determined to not be sensitive with a diagonal fill pattern.

At stage B, the security posture manager 101 obtains risk assessments for each sensitive asset discovered from the scanning. The security posture manager 101 interacts with the cybersecurity system 103 to obtain the risk assessments across the different aspects of risk. The risk assessments are generally represented in FIG. 1 as R1-R4 for the four different risk assessments corresponding to the different risk aspects. While this example presumes the obtained risk assessments are quantities, a risk assessment may be qualitative and converted to a quantity for this scoring system. The policy compliance risk assessment R1 is based on organizational behavior and/or an organization's policy, thus will be common across the sensitive assets. This may be a sensitivity classification according to a company policy, for instance. The user/device risk assessment R2 for each sensitive asset likely varies across the sensitive assets but some may be in common depending upon permissions (e.g., role based permissions and departmental organization) of the sensitive assets. Similarly, the application/configuration risk assessment R3 likely varies depending upon the configurations across sensitive assets but commonalities of configurations can exist. For instance, a sub-directory may be configured with a delete and edit permission that impacts risk assessment of sensitive assets in the sub-directory path. The risk assessment R4 will be for each of the cloud infrastructures 107, 109. Thus, the risk assessment for the cloud infrastructure 107 will be a factor in the scoring of the sensitive assets in the cloud infrastructure 107. Likewise, the risk assessment for the cloud infrastructure 109 will be a factor in the scoring of the sensitive assets hosted in the cloud infrastructure 109, for instance, assessment of risk based on existing vulnerabilities and remediations for a cloud platform/service.

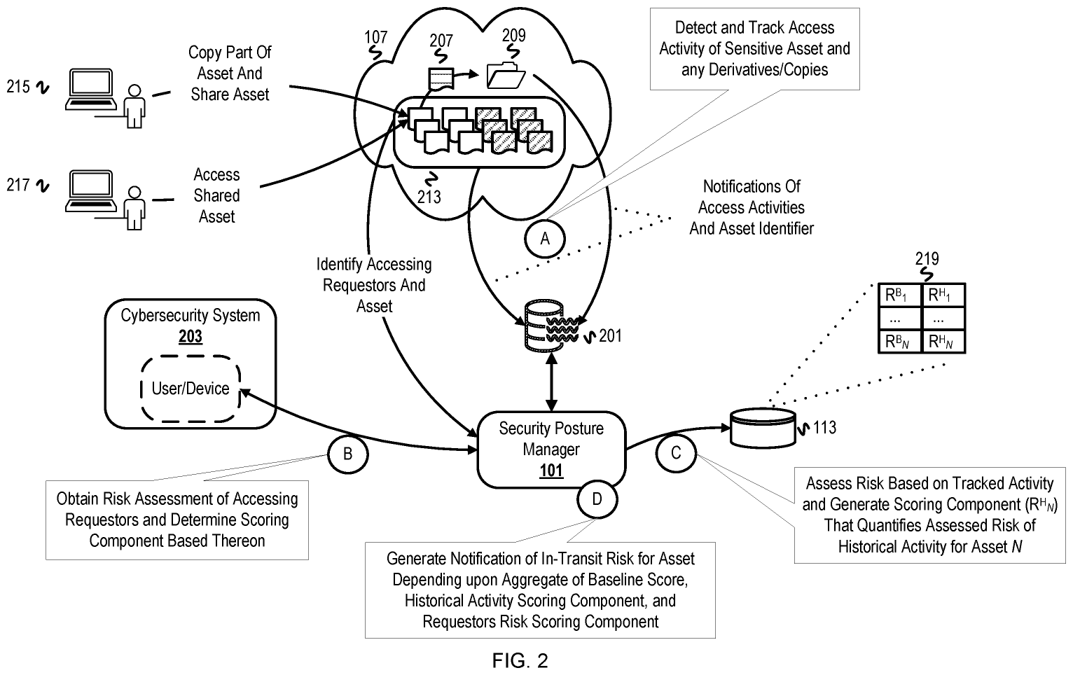

At stage C, the security posture manager 101 scores baseline at-rest risk of each sensitive asset based on the obtained risk assessments. The “at-rest” risk is the data loss risk for a sensitive asset while the data is in an at-rest state, i.e., the data loss risk when the asset is not being accessed (e.g., not being used, copied, moved, etc.). FIG. 1 depicts baseline at-rest risk score for a sensitive asset N (R^{B}_{N}) as a function of the obtained risk assessments. Each of the risk assessments is a quantified assessment of the corresponding risk aspect. The cybersecurity system 103 provides the risk assessments as numerical values. The security posture manager 101 calculates R^{B}_{N} as a sum of the individual risk assessments and can apply weighting as configured by an organization. The security posture manager 101 generates the baseline at-rest risk scores 111 and stores them in a repository 113. Scoring components accounting for dynamic risk aspects will also be added into the repository 113, which will be described later with reference to FIG. 2.

At stage D, the security posture manager 101 surfaces DLP incidents filtered based on the calculated baseline at-rest risk scores. The security posture manager applies a filter 117 to the baseline risks 111 of the sensitive assets. The filter indicates a score threshold used to filter out those of the DLP incidents 115 corresponding to sensitive assets with baseline at-rest risk scores below (exclusive or inclusive) the score threshold. The resulting filtered DLP incidents 121 are surfaced to a network administrator and/or security operations center administrator. Surfacing can be updating a visualization, generating an alarm, etc. Surfacing refers to bringing attention to information or data points among a large amount of information or data points.

FIG. 2 is a diagram of the example security posture manager determining scoring components that quantify dynamic risk aspects and evaluating both the baseline at-rest risk and dynamic scoring components. The dynamic scoring components quantify risk of historical accessing behavior as represented by access activity over time and risk of requestor requesting an access activity. This effectively captures dynamic risk over time and dynamic risk of a currently requested activity. FIG. 2 illustrates activity on a sensitive asset in the cloud infrastructure 107. FIG. 2 illustrates stages of operations A-D.

At stage A, access activity on a sensitive asset (asset N) in the cloud infrastructure 107 is detected and tracked. Assets of an organization are in a logical container 213 (e.g., a directory). Detection of activities can be done according to various implementations. For example, the security posture manager 101 can deploy agents to monitor for access activity at application programming interfaces (APIs) of the cloud infrastructure 107 or register for notifications of activity from the cloud infrastructure 107. FIG. 2 depicts detection of three access activities: share, copy, and access based on the share. A user 215 changes a permission or provides a hyperlink or path to a user 217 to share a sensitive asset. The user 217 then accesses the shared, sensitive asset. The user 215 also copies part of the sensitive asset creating a derivative 207 in a private container 209 (e.g., folder or directory) of the user 215. Indications of these access activities are recorded into a data lake 201 for tracking access activities over time per sensitive asset. Access activities would be tracked per sensitive asset with independent tracking of copies/derivatives, although the entries for copies/derivates of an asset can include an indication of a relationship with a “source” asset. This would allow for both aggregate scoring of sources and derivatives/copies and independent scoring by asset. Tracking of activities would be limited to cloud infrastructures of the organization or activities visible by the security posture manager 101. For instance, the security posture manager 101 can track activity that indicates a sensitive asset derivative being moved out of the cloud infrastructure 107 but likely loses visibility of activities thereafter. The notifications or indications of the access activities recorded into the data lake 201 associate an asset identifier with an activity.

At stage B, the security posture manager 101 obtains risk assessments of access requestors and determines a scoring component based on the risk assessments. In addition to the access activities being tracked over time, each detected access request triggers a communication to the security posture manager 101 that identifies the requestor and the sensitive asset. When user 215 creates the derivative 207, a notification is communicated to the security posture manager 101 identifying the requestor (e.g., an account identifier or user identifier of user 215), identifying the sensitive asset, and the copy activity. The same is done when user 215 shares the sensitive asset with user 217 and when user 217 requests access (e.g., view or read) based on the sharing. For each activity, the security posture manager 101 obtains a risk assessment of the identified requestor from a cybersecurity system 203 that at least provides a user/device risk assessment. Depending upon implementation, the security posture manager 101 may cache a risk assessment of a requestor until an defined expiration period to avoid successive requests for a same requestor. The obtained risk assessment of a requestor may be the scoring component. While FIG. 2 depicts the requestors as users, a requestor may be a process or device.

At stage C, the security posture manager 101 assesses risk based on tracked activity and generates a corresponding scoring component R^{H}_{N} that quantifies the assessed risk of the tracked activity of asset N. The security posture manager 101 may assess risk of tracked activity over time according to a schedule or assess risk of tracked activity coincident with detected activity for a sensitive asset. Thus, stage C is not necessarily subsequent to stage B. If a scoring component R^{H} already exists for a sensitive asset, then the security posture manager 101 updates the scoring component R^{H}. Example partial view 219 of the repository 119 depicts entries for each sensitive asset that include the baseline at-rest risk score and the historical activity scoring component.

At stage D, the security posture manager 101 generates a notification of in-transit risk of the sensitive asset depending upon an aggregate of the baseline at-rest risk, the historical activity scoring component, and the requestor risk scoring component. Similar to surfacing DLP incidents based on the baseline at-rest risk score, the security posture manager 101 may determine whether the aggregate of the baseline at-rest risk score and scoring components satisfies a score threshold defined to regulate which notifications are surfaced. Unlike the baseline at-rest risk score, the addition of the historical activity scoring component and the requestor scoring component provides both a current and historical context of activity risk that can be layered upon the baseline at-rest risk score. Thus, a data loss risk score can be presented for a sensitive asset that accounts for at-rest risk and in-transit risk.

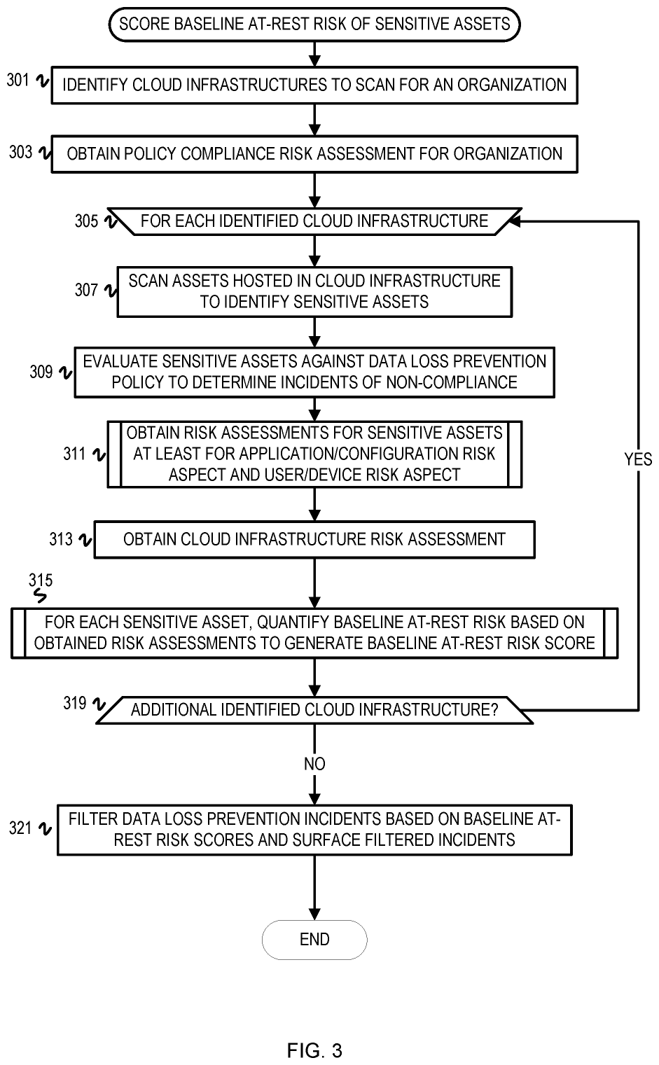

FIGS. 3-6 are flowcharts of example operations that are less scenario-specific than the diagrams of FIGS. 1-2. The operations of the flowcharts are described with reference to the security posture manager as the actor for consistency with FIGS. 1-2. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for scoring baseline at-rest risk of sensitive assets. These example operations correspond to embodiments that iterate through cloud infrastructures of an organization. This can be done as an initial inventory of sensitive assets hosted in the cloud, follow up inventories, migrations, etc.

At block 301, the security posture manager identifies cloud infrastructures to scan for an organization. An organization may have multiple accounts with a cloud provider that are specified to the security posture manager. The accounts can be identified via a user interface or in a file input to the security posture manager.

At block 303, the security posture manager obtains a policy compliance risk assessment for the organization. For example, the security posture manager invokes a function via a defined interface of a system or subsystem that assesses risk based on policy compliance across an organization and/or risk based on existing policy(ies) of the organization.

At block 305, the security posture manager begins iterating through the identified cloud infrastructures. This can be iterating through Anything-as-a-Service (XaaS) offerings of a cloud service provider, iterating through cloud platforms, iterating through XaaS offerings of multiple cloud service providers, etc.

At block 307, the security posture manager scans the cloud infrastructure to identify sensitive assets. The security posture manager may include the scanning functionality or invoke a separate tool to scan the cloud infrastructure. Scanning to identify sensitive assets would examine metadata and content of the assets to determine whether the metadata and/or content satisfy the organization's criteria for an asset to be sensitive.

At block 309, the security posture manager evaluates the sensitive assets against a data loss prevention policy to determine incidents of non-compliance. The security posture manager, for instance, invokes a DLP tool or service of the organization to detect the DLP incidents.

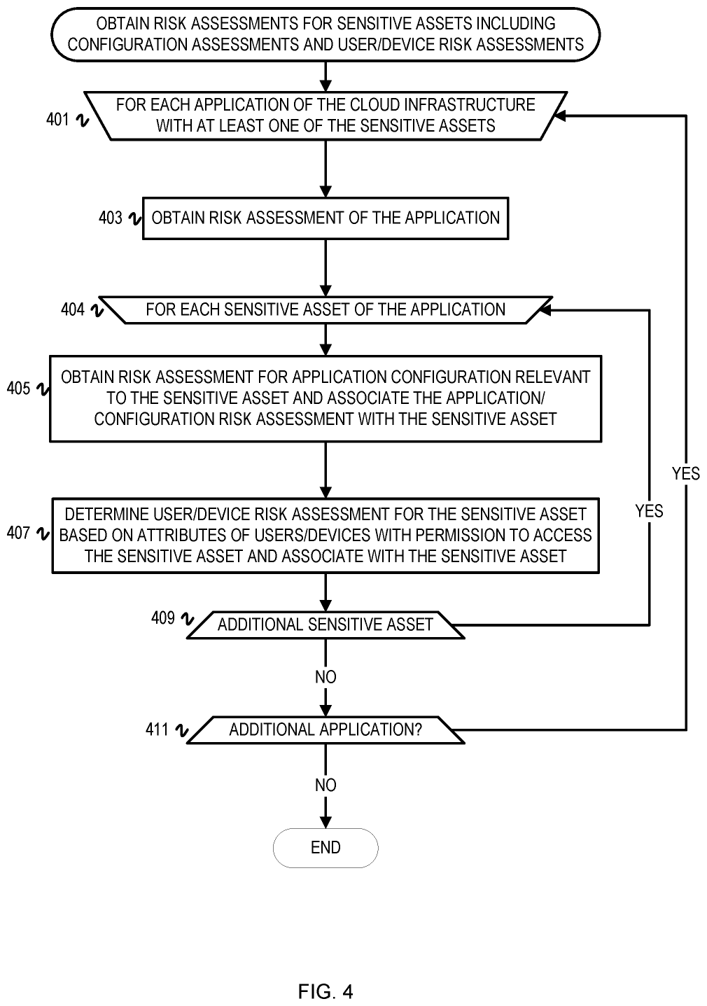

At block 311, the security posture manager obtains risk assessments for the sensitive assets. The risk assessments are at least for the risk aspects application/configuration and user/device. The security posture manager queries or invokes a system(s) or subsystem(s) that provides the risk assessments. Example operations for block 311 are depicted in FIG. 4.

At block 313, the security posture manager obtains a risk assessment for the cloud infrastructure. The security posture manager can interface with a system or subsystem that provides the risk assessment. For instance, the security posture manager submits a query or invokes a function defined by an API of the risk assessment system to obtain the risk assessment for the cloud infrastructure. The submission would include an identifier of the cloud infrastructure.

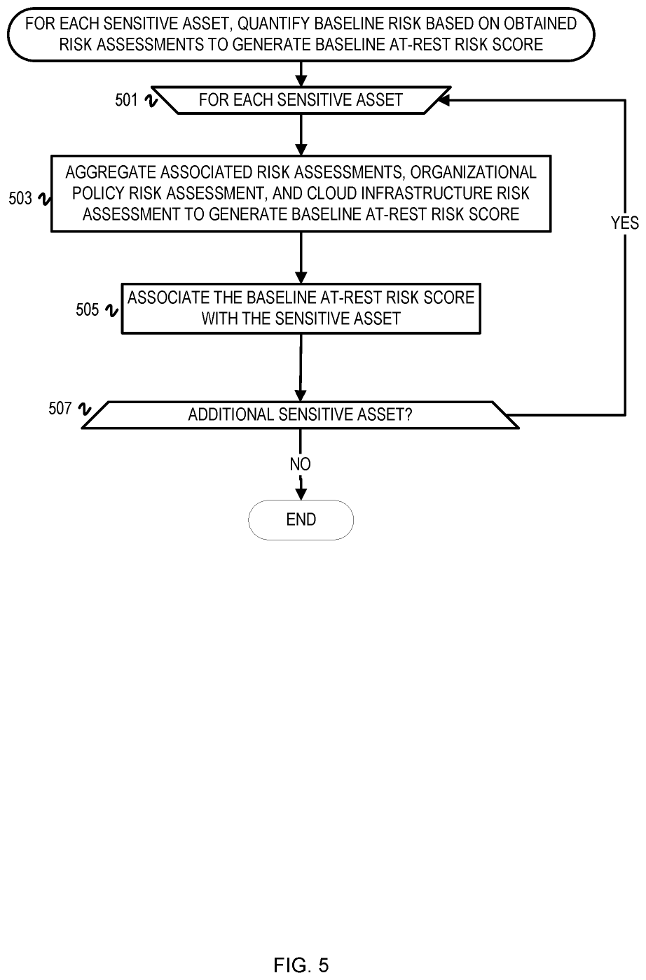

At block 315, the security posture manager quantifies the baseline at-rest risk assessment for each sensitive asset of the cloud infrastructure based on the obtained risk assessments. Each sensitive asset will be associated with the asset specific assessments and shared risk assessments. For instance, the security posture manager will have obtained a user/device risk assessment for a sensitive asset N based on user/device attributes for users/devices that can access the asset N. The security posture manager will have obtained a configuration risk assessment for sensitive asset N based on a SaaS assessment and configuration of the asset N. The security posture manager would then aggregate these risk assessments with the risk assessments that are shared-the policy compliance risk assessment and the cloud infrastructure risk assessment. Example operations for block 315 are provided in FIG. 5.

At block 319, the security posture manager determines whether there is another identified cloud infrastructure to process. The security posture manager may be iterating through cloud infrastructure accounts of an organization or receiving inputs from a user interface. If there is another identified cloud infrastructure, operational flow returns to block 305. If there is not another identified cloud infrastructure, operational flow proceeds to block 321.

At block 321, the security posture manager filters the detected DLP incidents (generated for each cloud infrastructure at block 309) based on the baseline at-rest risk scores of the corresponding sensitive assets. The security posture manager then surfaces the filtered DLP incidents. Surfacing the DLP incidents can be generating alarms/notifications, updating a file, updating a visualization of DLP incidents, etc.

FIG. 4 is a flowchart of example operations for obtaining risk assessments for the sensitive assets. These example operations of FIG. 4 presume implementations that treat different instances of data/program code (e.g., a file) as different assets for scoring purposes. For instance, a file may be hosted in different SaaS applications offered by a cloud service provider (i.e., cloud infrastructure). Each instance of the data/program code would have a different identifier which would be associated with its corresponding risk assessments. A security posture manager can create an in-memory structure or file to maintain the obtained risk assessments in association with sensitive asset identifier. At block 401, the security posture manager begins iterating through applications of the cloud infrastructure that host at least one of the sensitive assets, if there is more than one application.

At block 403, the security posture manager obtains a risk assessment of the application. This would be a general risk assessment of the application that is not specific to the sensitive assets. For instance, a SaaS application SaaS_Example can have a risk assessment independent of the organization specific configuration of the application. The security posture manager can submit an application identifier with a request to a security system to obtain the risk assessment.

At block 404, the security posture manager begins processing each of the sensitive assets hosted by the application. At block 405, the security posture manager obtains a risk assessment for the organization specific configuration of the application relevant to the sensitive asset and associates the application/configuration risk assessment(s) with the sensitive asset. An example of organization specific configuration of an application may be a current version of a client of the application. However, application configuration relevant to the sensitive asset may be at a finer granularity. For instance, an application configuration of create, read, update, delete (CRUD) permissions set for the asset or in a logical container (e.g., folder or directory). Thus, the application configuration risk assessment is possibly shared by multiple sensitive assets but not necessarily shared, which leads to obtaining the application/configuration risk assessment(s) for each sensitive asset. The security posture manager can submit an asset identifier with a request to a security system to obtain the application configuration risk assessment, which the security system likely has determined in advance but can determine in response to the request. If the application risk assessment and the configuration risk assessment are obtained as separate values, the security posture manager combines the values (e.g., averages the values or sums the values).

At block 407, the security posture manager determines a user/device risk assessment for the sensitive asset based on attributes of users/devices with permission to access the sensitive asset and associates the user/device risk assessment with the sensitive asset. For instance, the security posture manager submits an asset identifier to a security system (e.g., user and entity behavior (UEB) system) which will return a risk assessment.

At block 409, the security posture manager determines whether there is an additional sensitive asset to process. If so, operational flow returns to block 404. If not, operational flow proceeds to block 411.

At block 411, the security posture manager determines whether there is an additional application of the cloud infrastructure that hosts at least one sensitive asset. If so, operational flow returns to block 401. Otherwise, the example process of FIG. 4 ends and operational flow continues with scoring operations based on the obtained risk assessments.

FIG. 5 is a flowchart of example operations for quantifying the baseline at-rest risk assessment for each sensitive asset based on obtained risk assessments. The example operations for quantifying the baseline at-rest risk with the obtained assessments, or scoring baseline at-rest risk, proceeds after obtaining the risk assessments for the different aspects of risks for the sensitive assets hosted in a cloud infrastructure. These example operations are described based on an assumption the sensitive assets are associated with their corresponding risk assessments, for example sensitive asset entries are indexed by asset identifiers that refer to or index an array of the risk assessments to preserve the individual values and allow for drill-down analysis of the baseline at-rest risk score. At block 501, the security posture manager begins operations to score each of the sensitive assets. At block 503, the security posture manager aggregates the associated risk assessments, the organizational policy risk assessment, and the cloud infrastructure risk assessment to generate the baseline at-rest risk score. Implementations for aggregating the risk assessments into a score can vary. Weights can be applied to bias individual risk aspects according to organizational preferences. If the scoring is on a scale, for example 0 to 100, the security posture manager may normalize one or more of the risk assessments before aggregating. Aggregating can be averaging or summing the risk assessments. At block 505, the security posture manager associates the baseline at-rest risk score with the sensitive asset. The security posture manager stores the scores indexed by asset identifier, for example, in a repository. At block 507, the security posture manager determines whether there is an additional sensitive asset to process. If so, operational flow returns to block 501. If not, operational flow ends for FIG. 5.

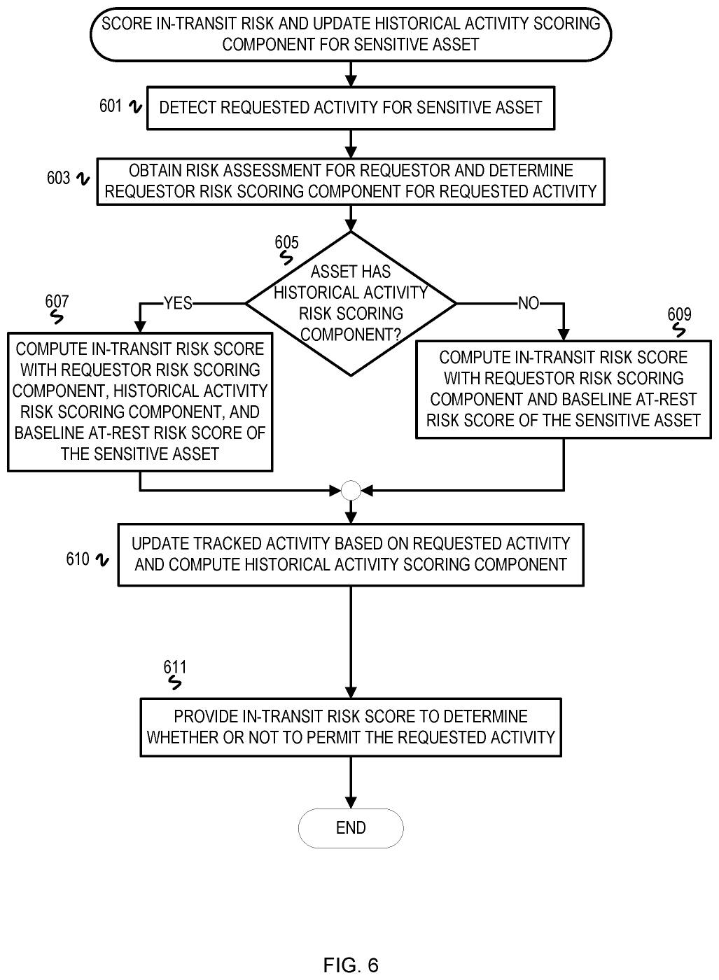

FIG. 6 is a flowchart of example operations for scoring in-transit risk for a sensitive asset and updating a historical activity scoring component. The previously described scoring of baseline at-rest risk does not account for additional risk aspects of an activity or in (quasi) real-time. Dynamic risk aspects, such as an activity and a requestor of the activity, can increase data loss risk of a sensitive asset. When a request to access a sensitive asset is detected, the security posture manager updates activity tracking and scores the activity.

At block 601, a security posture manager detects a requested activity for a sensitive asset. As mentioned earlier, the security posture manager can install or deploy agents that monitor APIs of a SaaS application/service or register with a cloud provider for notifications of activity on sensitive assets of an organization. Detection would involve the security posture manager receiving the asset identifier, a requestor identifier, and an activity type. For example, a user copies content from a sensitive asset in an authorized SaaS account of an organization to a document in an unauthorized SaaS account of the user. The SaaS service of the authorized account will capture a user identifier, the type of request (copy), a target of the request (the sensitive asset), and the destination of the copy request. The SaaS infrastructure will report this captured information to the security posture manager based on previous registration or SaaS configuration.

At block 603, the security posture manager obtains a risk assessment for the identified requestor and determines a requestor risk scoring component for the requested activity. The security posture manager can submit a request to a UEB system with the user identifier and the indication of the requested action to obtain a risk assessment. The security posture manager may normalize the obtained risk assessment to determine the scoring component. For example, the security posture manager may apply a coefficient to reduce the magnitude of the risk assessment to be used as a scoring component in combination with the baseline at-rest risk score.

At block 605, the security posture manager determines whether the sensitive asset has a historical activity scoring component. The security posture manager accesses a repository of scores and scoring components for sensitive assets of the organization. If there is no historical activity scoring component, then no activity has been detected since activity tracking began and operational flow proceeds to block 609. If there is a historical activity scoring component, then operational flow proceeds to block 607 for updating of the component based on the detected activity.

At block 607, the security posture manager computes an in-transit risk score with the requestor risk scoring component, historical activity risk scoring component, and the baseline at-rest risk score of the sensitive asset. The security posture manager uses the asset identifier to retrieve the baseline at-rest risk score and the historical activity scoring component. To compute the in-transit risk score, the security posture manager aggregates the baseline at-rest risk score with the requestor risk and the historical activity scoring components. The aggregating may be summing the baseline at-rest risk score with the scoring components. The security posture manager may be programmed to aggregate the score and scoring components depending upon various conditions. For instance, an access activity or set of access activities can be specified as being a severity that outweighs or overrides the at-rest score to an extent that handling the activity is done without regard to the at-rest risk score. Likewise, requestor risk can be so severe that the at-rest risk score cannot make the risk greater. In some cases, the security posture manager produces a reduced risk by subtracting a risk score of a user from the at-rest risk score. For instance, a set of users may be defined as no risk with a value that can be used to reduce an at-rest risk score of a sensitive asset.

At block 609, the security posture manager computes an in-transit risk score with the requestor risk scoring component and the baseline at-rest risk score of the sensitive asset since there is no historical activity risk scoring component. The security posture manager uses the asset identifier to retrieve the baseline at-rest risk score.

After computing the in-transit risk score, the security posture manager updates tracked activity on the sensitive asset based on the requested activity and computes the historical activity scoring component at block 610. Tracking of the activity per sensitive asset is not necessarily done by the security posture manager. Embodiments may track activity per sensitive asset by a separate system that stores the activity into a repository accessible by the security posture manager. The security posture manager can retrieve the tracked activity and assess risk of activity over time. The tracked activity may be windowed and/or the risk assessment may be for a configurable window of the tracked activity. Assuming tracked activity includes historical access activity within at most recent 4 weeks, the security posture manager can sum the risk assessments of these activities. Some activities may reduce risk and be subtracted, for example, from the accumulated sum. If an activity lacks a defined risk assessment quantification, the security posture manager can use values of similar activities. For example, the security posture manager can use the risk assessment of a requestor as the risk assessment of a copy action.

At block 611, the security posture manager provides the in-transit risk score for determining whether or not the requested activity should be permitted. The security posture manager may generate a notification or update a visualization based on the in-transit risk score. Embodiments can implement the security posture manager with the functionality to permit or deny the requested activity based on the in-transit risk score.

The mechanism for detecting requested activities that trigger in-transit risk scoring can also be used for triggering a re-assessment of the at-rest risk score of a sensitive asset. The sensitive assets for which the at-rest score would be re-calculated or re-assessed would vary based on the activity. For example, a configuration change to an application/service would trigger a re-assessment of the at-rest risk scores of the sensitive assets hosted in the cloud infrastructure corresponding to the application/service. If the separate risk assessments are maintained per sensitive asset, then the security posture manager can obtain the risk assessment corresponding to the change and then recalculate the at-rest risk of the impacted sensitive assets. If the configuration change is to a CRUD permission of a sensitive asset, the scope of re-assessment would be the single impacted sensitive asset.

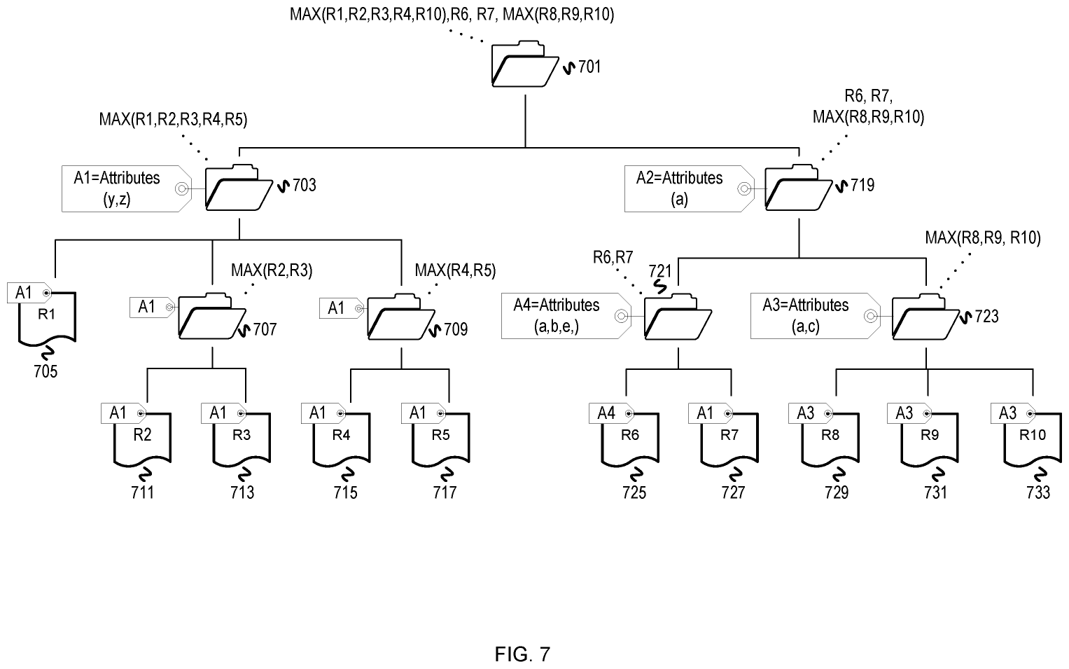

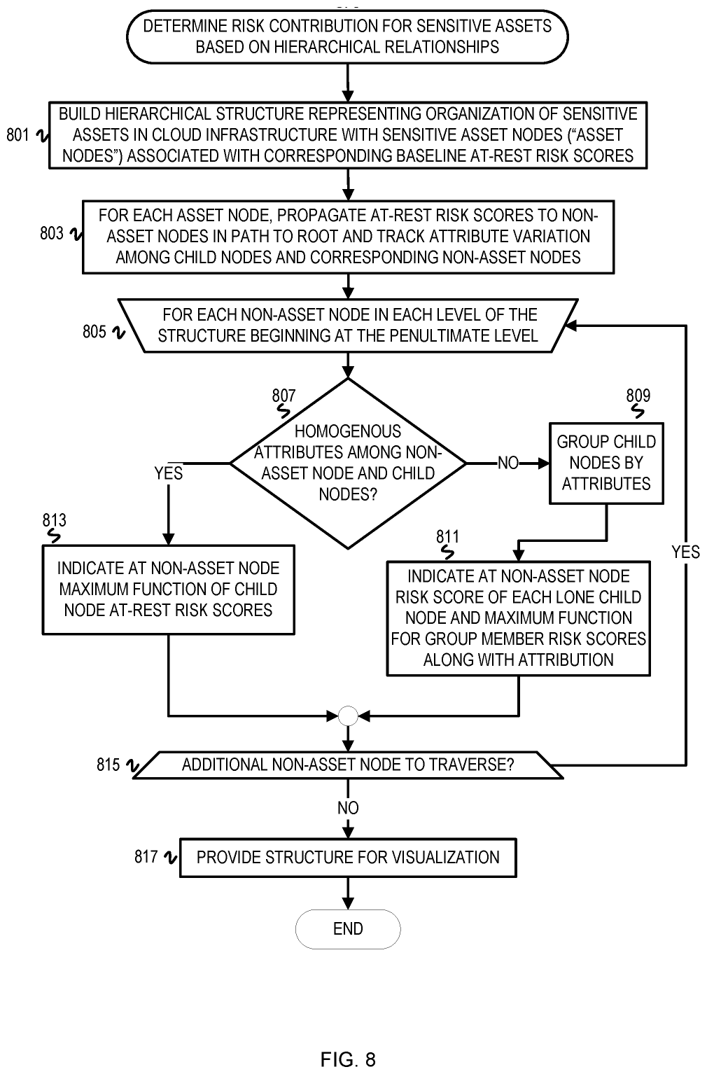

In addition to using the risk scores for surfacing notifications and evaluating requested activities on sensitive assets, the baseline at-rest risk scores can be used in analyzing the causes of risk or at least efficiently locating high-risk sensitive assets. FIGS. 7 and 8 relate to using the baseline at-rest risk scores and organizational relationships of sensitive assets to trace contributions to risk. FIG. 7 will be introduced and then used to illustrate the operations of FIG. 8.

FIG. 7 is a diagram of a hierarchy of sensitive assets and logical containers with indications of attributes and baseline at-rest risk scores (hereinafter “risk scores”). Each logical container is depicted as a folder in FIG. 7. A logical container 701 is a root of the hierarchy of sensitive assets 705, 711, 713, 715, 717, 725, 727, 729, 731, 733. Each of the sensitive assets is depicted with a risk score. The sensitive assets 705, 711, 713, 715, 717, 725, 727, 729, 731, 733 have risk scores R1-R10. The logical containers and the sensitive assets have attributes configured relating to access, such as CRUD settings and user-specific permissions. The attributes are generically depicted as a, b, c, e, y, and z. Collections of the attributes are depicted as A1-A4. A1 represents attributes (y,z). A2 represents attribute a. A3 represents attributes (a,c). A4 represents attributes (a,b,e). The root container 701 has logical containers (i.e., nested folders or sub-directories) 703, 719. The container 703 includes the sensitive asset 705 and logical containers 707, 709. The logical container 707 includes sensitive assets 711, 713. The logical container 709 includes the sensitive assets 715, 717. The logical container 719 includes logical containers 721, 723. The logical container 721 includes the sensitive assets 725, 727. The logical container 723 includes sensitive assets 729, 731, 733.

FIG. 8 is a flowchart of example operations for determining risk contribution for sensitive assets based on hierarchical relationships of the sensitive assets. This information can be used for a visualization of risk across sensitive assets based on organization of the sensitive assets by bubbling up (e.g., propagating along a path from leaf to root) baseline at-rest risk scores according to commonality of attributes. Consider a directory of thousands of assets across hundreds of sub-directories. Although the assets in FIG. 7 are sensitive assets, a real-world scenario likely has a mixture of assets with different sensitivity classifications including those that are not sensitive. A visualization with the underlying hierarchical risk contribution would aid in efficiently locating sensitive assets within a cloud infrastructure.

At block 801, the security posture manager builds a hierarchical structure representing an organization of sensitive assets in a cloud infrastructure with sensitive asset nodes (“asset nodes”) associated with corresponding baseline at-rest risk scores. If available from the cloud infrastructure, the security posture manager can request a hierarchical structure from the cloud infrastructure and then populate asset nodes with the baseline at-rest risk scores. Otherwise, the security posture manager can trace the organization of the sensitive assets to build the structures.

At block 803, the security posture manager propagates the at-rest risk scores of each asset node to non-asset nodes in a path(s) to the root and tracks attribute variation among child nodes and corresponding asset nodes. The security posture manager traverses nodes of the structure from the asset nodes, which are leaf nodes, to the root. While traversing, the security posture manager indicates the risk score of the asset node in traversed non-asset nodes. In addition, the security posture manager also tracks the attributes of the traversed nodes. If attributes diverge, then the different attributes are tracked by path.

At block 805, the security posture manager traverses the non-asset nodes in each level of the hierarchical structure beginning at the penultimate level of the hierarchical structure.

At block 807, the security posture manager determines whether the tracked attributes for the non-asset node are homogenous (e.g., the permissions or settings are the same for the non-asset node and the child nodes). If the attribute(s) among the non-asset node and child nodes are homogenous, then operational flow proceeds to block 813. If the attributes diverged on the path, then operational flow proceeds to block 809.

At block 809, the security posture manager groups child nodes by attributes. Referring to FIG. 7, the security posture manager groups the sensitive asset 725 and the folder 721 by attribute set A4. The security posture manager groups the sensitive assets 729, 731, 733 and the non-asset node 723 by attribute set A3. The security posture manager groups the sensitive asset 705 into a single member group by attribute set A1. Grouping by common attributes involves tracking the information and does not require literally organizing the nodes into groups.

At block 811, the security posture manager indicates at the non-asset node the risk score of each lone child node and a maximum function for a group of member risk scores along with attribution. Referring to FIG. 7, the security posture manager indicates at non-asset node 721 the risk score R6 for the sensitive asset node with A4 attribute set and the risk score R7 for the sensitive asset node 727 with the Al attribute set since the child nodes' attributes diverge.

At block 813, for the non-asset node with homogenous attributes, the security posture manager indicates at the non-asset node a maximum function of risk scores of the child asset nodes. Referring to FIG. 7, the security posture manager indicates at the non-asset node 723 a maximum function for the risk scores R8-R10 from the sensitive asset nodes 729, 731, 733 which have the attribute set A3 in common. Similarly, the security posture manager indicates at the non-asset node 707 a maximum function for the risk scores R2 and R3 from the sensitive asset nodes 711, 713 which have the attribute set A1 in common. The security posture manager indicates at the non-asset node 709 a maximum function for the risk scores R4 and R5 from the sensitive asset nodes 715, 717 which have the attribute set A1 in common.

At block 815, the security posture manager determines whether there is another non-asset node to traverse. If so, operational flow returns to block 805. If not, operational flow proceeds to block 817.

At block 817, the security posture manager provides the hierarchical structure for visualization. For instance, the security posture manager communicates the hierarchical structure to a visualization engine.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in FIG. 3 for obtaining risk assessment can be performed at different times with respect to the other operations. The organization and cloud infrastructure risk assessments can be obtained in parallel. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

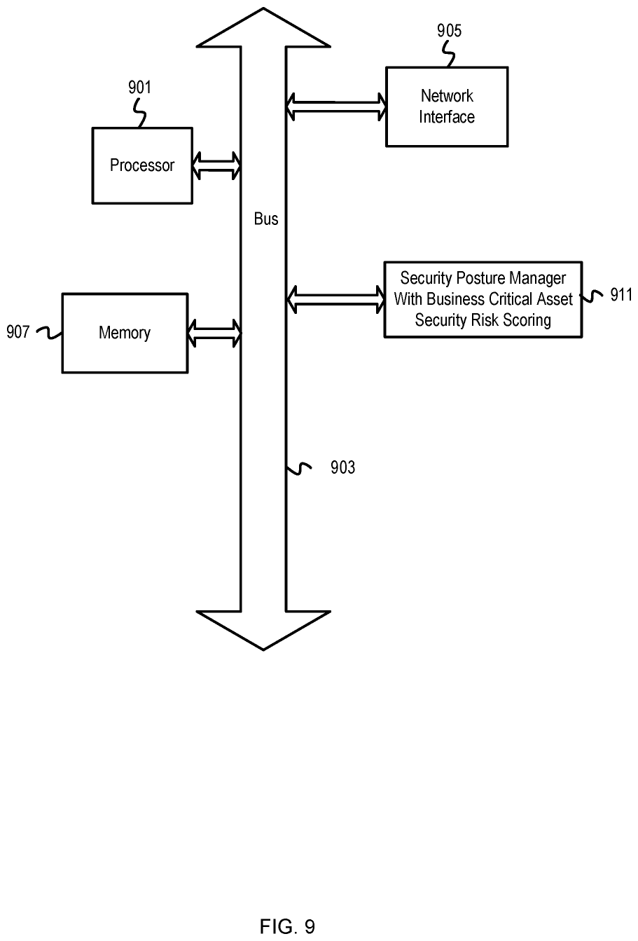

FIG. 9 depicts an example computer system with a security posture manager that scores data loss risk of business critical assets. The computer system includes a processor 901 (possibly including multiple processors, multiple cores, multiple nodes, and/or implementing multi-threading, etc.). The computer system includes memory 907. The memory 907 may be system memory or any one or more of the above already described possible realizations of machine-readable media. The computer system also includes a bus 903 and a network interface 905. The system also includes a security posture manager 911. The security posture manager 911 scores data loss risk of business critical assets according to at-rest scoring and in-transit scoring of risk. The security posture manager surfaces DLP incidents based on the risk scoring and can evaluate access activity based on the at-rest scoring and in-transit scoring. In addition, the security posture manager 911 can generate hierarchical scoring for visualization of the risks in a hierarchical structure of assets and logical containers of assets according to common attributes as organized in a cloud infrastructure. Any one of the previously described functionalities may be partially (or entirely) implemented in hardware and/or on the processor 901. For example, the functionality may be implemented with an application specific integrated circuit, in logic implemented in the processor 901, in a co-processor on a peripheral device or card, etc. Further, realizations may include fewer or additional components not illustrated in FIG. 9 (e.g., video cards, audio cards, additional network interfaces, peripheral devices, etc.). The processor 901 and the network interface 905 are coupled to the bus 903. Although illustrated as being coupled to the bus 903, the memory 907 may be coupled to the processor 901.

### Terminology

This description uses shorthand terms related to cloud technology for efficiency and ease of explanation. When referring to “cloud infrastructure” this description is referring to the resources of a cloud service provider. For instance, a cloud can encompass the servers, virtual machines, and storage devices of a cloud service provider. In more general terms, a cloud service provider resource accessible to customers is a resource owned/manage by the cloud service provider entity that is accessible via network connections. Often, the access is in accordance with an application programming interface or software development kit provided by the cloud service provider.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
identifying a plurality of sensitive assets corresponding to data loss prevention (DLP) incidents, wherein the plurality of sensitive assets is hosted in a set of one or more cloud infrastructures;
determining a data loss risk score for each of the plurality of sensitive assets based, at least partly, on user-based risk assessment, cloud infrastructure risk assessment, system configuration risk assessment, and policy compliance risk assessment; and
determining which of the plurality of sensitive assets have a data loss risk score that satisfies a set of one or more criteria; and
surfacing those of the DLP incidents corresponding to a subset of the plurality of sensitive assets having data loss risk scores that satisfy the set of one or more criteria.

2. The method of claim 1, wherein determining the data loss risk score for each of the plurality of sensitive assets comprises:
obtaining policy compliance risk assessment and user-based risk assessment for an organization responsible for the plurality of sensitive assets;
obtaining a cloud infrastructure risk assessment for each cloud infrastructure; and
obtaining system configuration risk assessments for the plurality of sensitive assets,
wherein determining the data loss risk score for each sensitive asset of the plurality of sensitive assets comprises aggregating the policy compliance risk assessment, the user-based risk assessment, the cloud infrastructure risk assessment of the cloud infrastructure hosting the sensitive asset, and the system configuration risk assessment for the system configurations of the sensitive asset into the data loss risk score for the sensitive asset.

3. The method of claim 2, wherein obtaining the system configuration risk assessments comprises:
obtaining detected system misconfigurations corresponding to the plurality of sensitive assets and severity values for the detected system misconfigurations; and
associating the severity values with the plurality of sensitive assets based on commonality of detected misconfigurations;
wherein the aggregating comprises deriving a representative value for the severity values of detected misconfigurations associated with a sensitive asset and using the representative value in the aggregating.

4. The method of claim 1 further comprising:
based on detecting an access request for a first of the plurality of sensitive assets, determining a risk assessment of a requestor;
generating an in-transit data loss risk score based, at least in part, on the data loss risk score of the first sensitive asset and the risk assessment of the requestor; and
determining whether to surface a notification corresponding to the first sensitive asset based, at least in part, on the in-transit data loss risk score.

5. The method of claim 1 further comprising tracking access activity of the plurality of sensitive assets and quantifying the tracked access activity by sensitive asset as historical scoring components for the plurality of sensitive assets.

6. The method of claim 5, wherein tracking access activity of the plurality of sensitive assets comprises tracking access activity of copies and derivatives of the plurality of sensitive assets as well as the plurality of sensitive assets.

7. The method of claim 6, wherein quantifying the tracked access activity by sensitive asset comprises quantifying risk assessments of the tracked access activity of a sensitive asset and risk assessments of the tracked access activity of at least one of a derivative of the sensitive asset and a copy of the sensitive asset.

8. The method of claim 5 further comprising, for each of the plurality of sensitive assets with tracked access activity, periodically updating the data loss risk score of the sensitive asset with the historical scoring component or maintaining the historical scoring component of the sensitive asset distinct from the data loss risk score of the sensitive asset.

9. The method of claim 1 further comprising, for a subset of the plurality of sensitive assets hosted in a first of the cloud infrastructures, building a hierarchical structure representing data organization relationships among the subset of the plurality of sensitive assets and indicating data loss risk scores of the subset of sensitive assets at leaf nodes of the hierarchical structure and aggregating data loss risk scores by common access paths represented by interior nodes according to the data organization relationships.

10. The method of claim 1, wherein identifying the plurality of sensitive assets comprises scanning assets of an organization in each of the set of cloud infrastructures to identify sensitive and non-sensitive assets and to identify which of the sensitive assets yield DLP incidents while at rest.

11. A non-transitory, machine-readable medium having program code stored thereon, the program code comprising instructions to:
determine a set of one or more cloud infrastructures hosting sensitive assets for an organization;
quantify holistic data loss risk for sensitive assets of the organization hosted in the set of one or more cloud infrastructures, wherein the instructions to determine the holistic data loss risk comprise instructions to, for each cloud infrastructure,
obtain a risk assessment of the cloud infrastructure;
obtain system configuration risk assessments for the sensitive assets hosted in the cloud infrastructure;
obtain a risk assessment of policy compliance corresponding to the cloud infrastructure and the organization;
obtain user-based risk assessments for the sensitive assets hosted in the cloud infrastructure;
determine a baseline data loss risk score for each sensitive asset hosted in the cloud infrastructure based on a combination of the risk assessments for the sensitive asset; and
surface, to a security operations center, data loss prevention (DLP) incidents of the sensitive assets based, at least in part, on the baseline data loss risk scores.

12. The non-transitory, machine-readable medium of claim 11, wherein the instructions to obtain system configuration risk assessments for the sensitive assets hosted in each cloud infrastructure comprise instructions to determine severity values of detected security misconfigurations corresponding to those of the sensitive assets hosted in the cloud infrastructure, determine a representative value for severity values of detected security misconfigurations occurring for groups of the sensitive assets, and to associate the representative values to the sensitive assets by group membership.

13. The non-transitory, machine-readable medium of claim 11, wherein the instructions to determine a baseline data loss risk score for each sensitive asset hosted in the set of one or more cloud infrastructure based on a combination of the risk assessments for the sensitive asset comprise instructions to compute the baseline data loss risk score of a sensitive asset as a weighted average of values of the risk assessments corresponding to the sensitive asset, wherein weights are configurable.

14. The non-transitory, machine-readable medium of claim 11, wherein the program code further comprises instructions to:
track access activity corresponding to the sensitive assets;
based on detection of an access request for one of the sensitive assets, determine a risk assessment of a requestor corresponding to the access request;
for the sensitive asset corresponding to the detected access request,
generate an in-transit data loss risk score based, at least in part, on the baseline data loss risk score of the sensitive asset and the risk assessment of the requestor; and
determine whether to surface a DLP incident corresponding to the access request and the sensitive asset based, at least in part, on the in-transit data loss risk score.

15. The non-transitory, machine-readable medium of claim 11, wherein the program code further comprises instructions to track access activity of the sensitive assets and to quantify the tracked access activity by sensitive asset as historical scoring components for the sensitive assets.

16. The non-transitory, machine-readable medium of claim 15, wherein the program code further comprises instructions to, for each of the sensitive assets with tracked access activity, update the baseline data loss risk score of the sensitive asset with the historical scoring component of the sensitive asset.

17. The non-transitory, machine-readable medium of claim 15, wherein the program code further comprises instructions to, for each of the sensitive assets with tracked access activity, maintain the historical scoring component of the sensitive asset distinct from the baseline data loss risk score of the sensitive asset, wherein the instructions to surface, to a security operations center, data loss prevention (DLP) incidents of the sensitive assets based, at least in part, on the baseline data loss risk scores comprise the instructions to surface the DLP incidents also based on the historical scoring components.

18. The non-transitory, machine-readable medium of claim 11, wherein the program code further comprises instructions to, for at least one of the set of cloud infrastructure, build a hierarchical structure representing data organization relationships among a subset of the sensitive assets in the cloud infrastructure and indicate baseline data loss risk scores of the subset of sensitive assets at leaf nodes of the hierarchical structure and propagate baseline data loss risk scores towards a root of the hierarchical structure with aggregation of the propagated baseline exposure scores at shared interior nodes according to the data organization relationships.

19. An apparatus comprising:
a processor; and
a machine-readable medium having stored thereon instructions executable by the processor to cause the apparatus to,
determine a set of one or more cloud infrastructures hosting sensitive assets for an organization;
quantify holistic data loss risk for sensitive assets of the organization hosted in the set of one or more cloud infrastructures, wherein the instructions to determine the holistic data loss risk comprise instructions to, for each cloud infrastructure,
obtain a risk assessment of the cloud infrastructure;
obtain system configuration risk assessments for the sensitive assets hosted in the cloud infrastructure;
obtain a risk assessment of policy compliance corresponding to the cloud infrastructure and the organization;
obtain user-based risk assessments for the sensitive assets hosted in the cloud infrastructure;
determine a baseline data loss risk score for each sensitive asset hosted in the cloud infrastructure based on a combination of the risk assessments for the sensitive asset; and
surface, to a security operations center, data loss prevention (DLP) incidents of the sensitive assets based, at least in part, on the baseline data loss risk scores.

20. The apparatus of claim 19, wherein the instructions to obtain system configuration risk assessments for the sensitive assets hosted in each cloud infrastructure comprise instructions executable by the processor to cause the apparatus to determine severity values of detected security misconfigurations corresponding to those of the sensitive assets hosted in the cloud infrastructure, determine a representative value for severity values of detected security misconfigurations occurring for groups of the sensitive assets, and to associate the representative values to the sensitive assets by group membership.

21. The apparatus of claim 19, wherein the instructions to determine a baseline data loss risk score for each sensitive asset hosted in the set of one or more cloud infrastructure based on a combination of the risk assessments for the sensitive asset comprise instructions executable by the processor to cause the apparatus to compute the baseline data loss risk score of a sensitive asset as a weighted average of values of the risk assessments corresponding to the sensitive asset, wherein weights are configurable.

22. The apparatus of claim 19, wherein the machine-readable medium further has stored thereon instructions executable by the processor to cause the apparatus to:
track access activity corresponding to the sensitive assets;
based on detection of an access request for one of the sensitive assets, determine a risk assessment of a requestor corresponding to the access request;
for the sensitive asset corresponding to the detected access request,
generate an in-transit data loss risk score based, at least in part, on the baseline data loss risk score of the sensitive asset and the risk assessment of the requestor; and
determine whether to surface a DLP incident corresponding to the access request and the sensitive asset based, at least in part, on the in-transit data loss risk score.
